(19) United States
(12) Patent Application Publication
(10) Pub. No.: US 2007/0020767 A1
(43) Pub. Date: Jan. 25, 2007

(54) Processes and devices for the liquid treatment of suspended particles

(75) Inventor: Thomas Schnelle, Berlin (DE)

Correspondence Address: MORRISON & FOERSTER LLP, 425 MARKET STREET, SAN FRANCISCO, CA, 94105-2482, US

(73) Assignee: EVOTEC Technologies GmbH, 40225 Duesseldorf (DE)

(21) Appl. No.: 10/556,239

(22) PCT Filed: May 10, 2004
(86) PCT No.: PCT/EP04/04981

§ 371 Date: Sep. 19, 2006

(30) Foreign Application Priority Data
May 9, 2003 (DE) 103208690

(51) Int. Cl. G01N 1/10

(52) U.S. Cl. 436/180

(57) ABSTRACT

Processes are described for the treatment of at least one particle (10-13) with at least one reaction liquid (20) in a main channel (30) of a fluidic microsystem (100) with the following steps: movement of the at least one particle (10-13) with a carrier liquid (40) flowing in a longitudinal direction of the main channel (30) up to a holding device (50), at least a temporary holding of the at least one particle (13) under the action of a holding force exerted by the holding device (50), and supplying of the reaction liquid (20) from at least one lateral channel (31) into the main channel (30) so that the at least one held particle (13) is rinsed by the reaction liquid (20), the holding device (50) being arranged downstream after a mouth (32) of the lateral channel (31) in the main channel (30) and the reaction liquid (20) flowing through the holding device (50) with a direction of flow running in the longitudinal direction of the main channel (30). Fluidic microsystems and electrode arrangements for realizing the processes are also described.

The invention relates to processes for the treatment of at least one particle with at least one reaction liquid in a fluidic microsystem, especially processes for liquid treatment, in which at least one suspended particle is fixed in the channel of a fluidic microsystem in a holding device through which the at least one reaction liquid flows, and devices for carrying out such processes.

The manipulation of suspended particles in fluidic microsystems, e.g., for certain measurements, sortings, analyses, reaction courses or the like under the action in particular of electric and/or magnetic fields is known. The particles generally comprise microobjects with typical dimensions in the sub-mm range such as, e.g., biological cells, synthetic particles or liquid droplets in systems with separate liquid phases. The microsystem comprises at least one main channel through which the particles are moved with a carrier liquid and in which electrodes are arranged, e.g., for generating electrical fields. When the electrodes are loaded with high-frequency fields the particles can, e.g., be individualized, focused, sorted, individually locally positioned or parked in groups under the action of negative dielectrophoresis (see T.

Müller et al. in “Biosensors & Bioelectronics”, volume 14, 1990, pp. 247-256, and in “Bioworld”, volume 2/2, 2000, pp. 12-13).

A special task in the manipulation of particles in microsystems consists in exposing the suspended particles to a treatment liquid (reaction liquid in the following) in addition to the carrier liquid. The treatment with the reaction liquid can serve, e.g., to initiate specific chemical reactions or for purposes of washing.

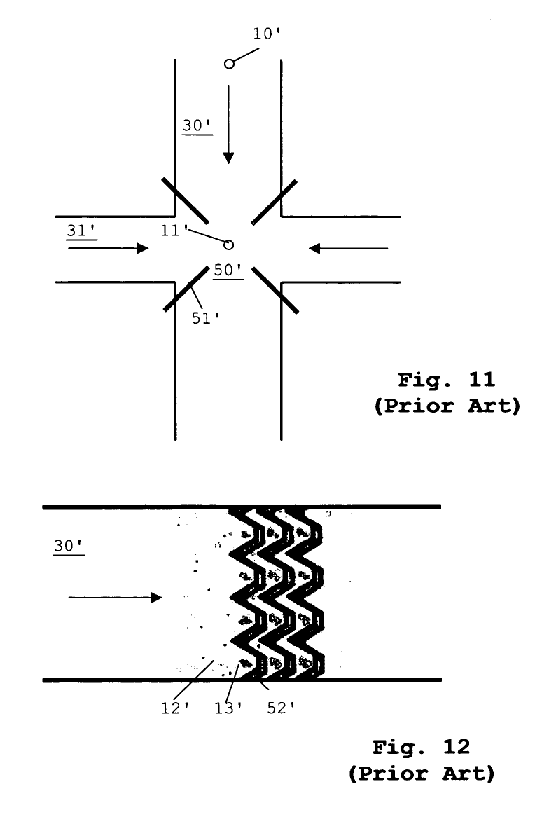

A fluidic microsystem is described by G. Gradl et al. in the publication “New Microdevices for Single Cell Analysis, Cell Sorting and Cloning-on-a-Chip: The Cytocon™ Instrument” (A.v.d. Berg et al. (editor): “Micro Total Analysis Systems” 2000, pp. 443-446, Kluwer Academic Publishers)) in which microsystem a main channel is perpendiculary crossed by a transverse channel through which the reaction liquid is conducted for the liquid treatment of particles. FIG. 11 schematically illustrates the crossing of main channel 30′ by transverse channel 31′. An arrangement of eight microelectrodes 51′ (octopole electrode arrangement) is provided at the intersection point as holding device 50′ for generating a dielectrical field cage. For a liquid treatment, particles 10′, 11′ are transported with the carrier liquid in main channel 30′ to holding device 50′ and individually held in the field cage produced by holding device 50′. Through transverse channel 31′, the reaction liquid is flushed through the holding device 50′. The technology described in the publication of G. Gradl et al. can be disadvantageous in certain applications in regard to the following problems.

Relatively low dielectrical holding forces are formed in the dielectrical field cage of the octopole electrode arrangement (e.g., <100 pN), which requires a very uniform flow with flow speeds that are not too high (<300 μm/s) as a function of the type of particle treated (e.g., biological cell, synthetic particles). The transverse channel 31′ must be equipped with additional pumps and, in particular with valves that are pulsation-free and free of dead volumes. This limits the possibility of parallelization (simultaneous treatment of a plurality of particles) and the operational reliability. Another problem can consist in that a part of the reaction liquid still at rest possibly diffuses before the desired start of a liquid treatment already out of transverse channel 31′ into holding device 50′. The action of the reaction liquid diffusing transversely to the carrier liquid can be reduced by increasing the flow rate of the carrier liquid. However, the increasing of the flow rate is possible only to a limited extent on account of the reasons cited above. Kinetic investigations in which the temporal dependency of the reaction of particle 11′ on the reaction liquid is to be detected are therefore only possible to a limited extent with the conventional system.

The publication of T. Müller et al. (see above) teaches generating curved field barriers transversely to the channel direction in channel 30′ of the fluidic microsystem with so-called park electrodes with which barriers suspended particles can be retained from being transported further with the carrier liquid. Park electrodes 52′, shown by way of example in FIG. 12, have a triangular or trapezoidal shape so that potential wells are formed in the direction of flow in which particles 12′ collect. The conventional park electrodes have the disadvantage that they are not suited for a stationary positioning of individual particles since they form no defined potential minimum but rather particles 12′ form irregular aggregates 13′ in the potential wells so that locally measurements or processing steps are excluded. Specific treatments can only take place after a release of the park electrode and a new individualization under the action of dielectrophoresis.

The invention has the object of providing improved processes and devices for the treatment of suspended particles with at least one reaction liquid in a channel of a fluidic microsystem with which the disadvantages of the conventional liquid treatment are overcome. Processes in accordance with the invention should be characterized in particular by a secure and reliable positioning of individual particles in a holding device and make possible kinetic investigations with a defined start of the treatment with the reaction liquid. Devices in accordance with the invention should have in particular a simplified electrode structure and make possible a more homogeneous treatment of particles. In general, the using of liquid treatment should be expanded relative to higher speeds of the carrier liquid. The particles treated in accordance with the invention should be accessible at the treatment site (in the holding device) for optical measuring processes.

These objects are solved by processes and devices with the features according to claims 1, 19, 36 and 39. Advantageous embodiments and applications of the invention result from the dependent claims.

As concerns the processes, the invention is based on the general technical teaching of carrying out the treatment of at least one suspended particle with at least one reaction liquid at a spatial distance from a supply site of the reaction liquid into a carrier liquid in which the particle is suspended. The reaction liquid flows from a lateral channel into the main channel with the carrier liquid and strikes the at least one particle only downstream after the coupling of the lateral channel. This measure fluidically simplifies the supply of the reaction liquid. Lesser requirements are placed on the uniformity of the supply of the reaction liquid. The cited problems due to an undesired diffusion of the reaction liquid are avoided. Limitations regarding the design of the holding device that were given in the conventional arrangement at the intersection point are avoided. The holding device can be adjusted with an increased holding force for an effective fixing of particles.

In particular, the invention makes it possible to design the holding device in such a manner that the at least one particle is individually held or a plurality of particles are positioned adjacent to each other as a straight or curved row along a potential line extending transversely to the direction of flow over the main channel. If the at least one particle is held on a local, substantially punctiform potential minimum or along the potential line, the formation of undefined aggregates or clumps as in the case of the conventional park electrodes can advantageously be avoided. In general, the holding on a potential minimum or along a potential line signifies that the site of the maximum holding forces is focused on a point or on a line. Contactless holding forces are preferably formed by high-frequency electrical fields (negative or positive dielectrophoresis), electrophoretic field effects, magnetic fields, optically mediated force effects or sound fields, whereby in these instances it is especially advantageous that appropriate devices such as, e.g., electrode arrangements for forming field cages or optical laser tweezers per se are available in microsystem technology. The holding forces can be repulsing or attracting forces in relation to the electrodes, especially when negative or positive dielectrophoresis is used, or optical forces that are maximal at the particular focus when optical holding devices are used (in accordance with the principle of laser tweezers).

It can be advantageous for the use of the invention in the treatment of biological particles such as, e.g., biological cells, cellular aggregates or cell components if the holding device is designed for a contactless fixing of the particles in a switchable force field. Contactless holding signifies that the particles in the holding device make no mechanical contact with electrodes, walls or other components of the channel. In the case of biological materials, this avoids undesired absorption reactions or other changes of the particles. The switchability of the holding device has the general advantage that after the treatment of the at least one particle with the reaction liquid, the at least one particle can be readily released and moved further in the channel.

An advantageous embodiment of the invention provides that the at least one particle is held downstream from the mouth of the lateral channel into the main channel outside of the middle of the main channel on its side that is limited by the channel wall in which the mouth of the lateral channel is formed (holding in the half of the main channel on the mouth side). In this instance the reaction liquid advantageously moves substantially without being mixed with the carrier liquid through the holding device.

According to a modified embodiment of the invention the holding device can be provided in the middle of the main channel, which is especially advantageous when several reaction liquids are supplied via several lateral channels from different sides into the main channel.

The at least one particle is held in the holding device preferably under the action of holding forces generated dielecrophoretically, optically or with ultrasound. The sources required for this such as, e.g., electrode arrangements for generating field barriers, optical laser tweezers or sound sources are advantageously available per se from conventional fluidic microsystem technology. The designing of the holding device can be advantageously simplified if the particle is held under the combined action of dielectrophoretical holding forces and mechanical flow forces. In this instance only a straight or curved field barrier has to be generated that extends over the main channel.

The combined action of the holding forces with the mechanical flow forces is especially significant if the holding forces form a potential well open on one side as is the case, e.g., with a bent electrode, and the particles might not be able to be reliably held in the potential well without the propulsive force mediated via the flow.

If the field barrier narrows in the longitudinal direction of the main channel down to the local potential minimum, advantages for the holding of individual particles can result. In particular, a so-called hexode electrode arrangement can be provided that is simpler to manage in comparison to the conventional field cages used at the intersection point of channels since fewer electrodes are required for a stable holding of the particle to be treated than in the octopole electrode arrangement. If the field barrier extends linearly and transversely to the longitudinal direction of the main channel many particles can be advantageously held simultaneously as a straight line. According to a preferred variant of the invention the liquid treatment of the at least one particle is combined in the holding device with the measuring of particle properties. The measuring comprises, e.g., an electrical measuring (e.g., impedance measuring, rotation measuring), an optical measuring (e.g., fluorescence measuring) and/or an optical image with a microscope.

Another exemplary embodiment of the invention provides that at least one reference particle is held in a reference holding device parallel to the liquid treatment of the at least one particle, in which reference holding device the reference particle is exposed exclusively to the carrier liquid (without the reaction liquid) or to a different reaction liquid than the investigated particle is. This makes it possible to compare the reaction of an investigated particle with the reference particle. In order to compare both objects, preferably at least one comparative measurement is carried out on the reference particle and compared with the measurement on the investigated particle.

If the reaction liquid is flushed in as a segmented liquid column in which segments of the reaction liquid and segments of a barrier liquid alternate, advantages for kinetic investigations can result. With the barrier liquid a premature diffusion from the reaction liquid into the main channel can be suppressed in an advantageous manner or the supply of the reaction liquid can be changed according to a certain timetable.

Special advantages of the invention can result if the distance of the positioning of the at least one particle from the mouth of the lateral channel for introducing the reaction liquid is selected in a range of 50 μm to 4 mm, especially from 50 μm to 2 mm. In this distance range on the one hand the cited diffusion problems and on the other hand a premature mixing of the reaction liquid and of the carrier liquids can be avoided. Depending on the application, even greater distances, e.g., 6 mm or more can be provided.

According to a preferred application of the invention, after the at least one particle held in the holding device has been rinsed with the reaction liquid a release of the particle from the holding device and a subsequent transporting of the particle with the liquid through the main channel or into a discharge channel is provided. In this manner differently treated particles can advantageously be transported further or sorted, e.g., as a function of a given treatment protocol for various applications. The release and further movement of the particle can, if the above-cited measuring was carried out in the held state, advantageously take place as a function of the measured result. If the at least one particle reacted to the treatment with the reaction liquid in a predetermined manner in which, e.g., a specific fluorescent dye coupled to a biological cell, a selection of the specifically reacting cell and its further transport through the main channel or the discharge channel can take place as a function of the result of the measuring, e.g., upon detection of the fluorescent dye. Particles that do not yield the desired result can be appropriately eliminated, in particular via the discharge channel, and separated from the fluidic process.

Thus, the combination of the treatment in accordance with the invention of the temporarily held particles with the reaction liquid with the subsequent deflection into a certain target channel from a group of several following channels advantageously represents a sorting process, in particular for biological particles, which exhibits an especially high reliability and selectivity.

According to a preferred embodiment of the invention the deflection takes place into one of the cited channels arranged downstream from the holding device under the action of high-frequency electrical fields. A deflection by negative or positive dielectrophoresis is provided that can advantageously be rapidly turned on or off.

According to other advantageous modifications of the invention the creation of dielectrophoretical field barriers is provided for screening the at least one lateral channel from the main channel and/or for screening the holding device, especially during the treatment of a fixed particle with the reaction liquid. These screening measures have the advantage that the selectivity of the liquid treatment and especially of the sorting can be significantly improved since the undesired influence of particles is avoided, e.g., in the at least one lateral channel and/or in the holding device.

The sorting function of the invention has the advantage of greater sorting reliability in comparison to conventional cellular sorters since certain field barriers can be selectively controlled in the course of the particle treatment, measuring and subsequent sorting in the microsystem in order to exclude undesired erroneous sortings.

As concerns the device, the invention is based on the general technical teaching that in a fluidic microsystem with a main channel for the carrier liquid with at least one suspended particle, at least one lateral channel for at least one reaction liquid which lateral channel empties into the main channel and with a holding device for the at least temporary fixing of the particle the holding device is arranged downstream after the mouth of the lateral channel in the main channel. A greater variability is advantageously made possible in the designing of the holding device for a fixing of the particles with a greater holding force by the introduction of a distance between the mouth of the lateral channel and the holding device with which the at least one particle can be fixed without contact with channel walls especially individually on a local potential minimum or as a series on a potential line.

According to a preferred embodiment of the invention the holding device comprises an electrode arrangement with which a potential well is generated that is closed at least in the direction of flow of the carrier liquid. Individual particles can be fixed in a particularly effective manner in the punctiform potential minimum of the potential well with the cooperation of mechanical flow forces and dielectrophoretical forces. The potential well can per se be generated with the conventional octopole electrode arrangement. However, a modified electrode arrangement is preferred in which an electrode is centrally arranged on the downstream side of the holding device. Advantageously, in this manner the holding force can be increased effectively against the direction of flow of the carrier liquid or of the reaction liquid.

A so-called hexode electrode arrangement is preferably provided comprising three electrodes on a bottom surface and on a cover surface of the main channel. Two of the electrodes extend from two sides into the main channel for the lateral delimitation of the potential well so that a distance is formed between their free ends. The third electrode is arranged downstream from the two lateral electrodes in the middle of the distance formed between the lateral electrodes. The flow rate of the carrier liquid and of the reaction liquid can be significantly raised in comparison to conventional fluidic microsystems with the hexode electrode arrangement, which represents an independent subject matter of the invention.

The holding force of the hexode electrode arrangement can be further raised in an advantageous manner if a field-forming structure is formed on the free end of the central electrode. Further advantages for the forming of the potential well can result if a field-forming additional electrode is additionally arranged upstream from the hexode electrode arrangement.

According to a modified embodiment of the invention the holding device comprises at least one pair of electrodes in the form of straight electrode strips arranged on the bottom and cover surfaces of the main channel. A dielectrical field barrier extending perpendicularly to the direction of flow and transversely over the main channel can advantageously be generated by loading the straight, strip-shaped electrodes with high-frequency alternating voltages. The particles are surprisingly positioned in a row by the cooperation of dielectrophoretical forces and mechanical flow forces. The held particles are arranged transversely to the direction of flow adjacent to each other in a straight row. This makes individual measurements possible even if a plurality of particles is to be treated at the same time with the liquid treatment of the invention.

The electrodes of a pair of electrodes strips can each be arranged opposite one another. This can improve the field effect in an advantageous manner. As an alternative, the electrodes of a pair can be staggered in the direction of flow. In this instance advantages regarding the arrangement of two particle rows on the one hand in the vicinity of the bottom surface and on the other hand in the vicinity of the cover surface of the main channel can result.

According to another embodiment of the invention the microsystem is provided with at least one measuring device for measuring the at least one particle in the holding device. The reaction of the particle to the reaction liquid can advantageously be detected and evaluated with an, e.g., optical or electrical measurement in real-time operation. It can be advantageous for reference investigations if the microsystem is also provided with a reference holding device for at least one reference particle and a reference measuring device.

According to a modified embodiment the holding device for a particle fixing can be arranged in the focus of an acoustic field. In this instance the holding device comprises at least one sound source for the generation of ultrasound.

If the microsystem in accordance with the invention comprises at least one discharge channel downstream from the holding device which channel branches off from the main channel, this can result in advantages for other, new applications of the microsystem. The at least one discharge channel makes possible the selection of non-treated particles, differently treated particles or of particles that do not react to the treatment with the reaction liquid as a function of the particular particle properties and/or a given process protocol. In particular, the above-cited sorting function of the microsystem of the invention can be improved in an advantageous manner with the at least one discharge channel.

According to another advantageous embodiment of the invention the microsystem is provided with at least one electrode for generating a dielectrophoretical field barrier in front of the branch of the discharge channel (sorting electrode), on the at least one lateral channel (barrier electrode) and/or between the mouth of the lateral channel and the holding device (screening electrode), which electrodes improve the selectivity and functionality of the microsystem individually or in combination.

The hexode electrode arrangement for holding at least one suspended particle in a channel of a fluidic microsystem constitutes an independent subject matter of the invention. The hexode electrode arrangement comprises at least three electrodes with a central electrode and two lateral electrodes that cooperate to generate a potential well open against the direction of flow in the channel and with a potential minimum. The central electrode is arranged in such a manner as to form a dielectrical field barrier transversely to a direction of flow in the channel when loaded with a high-frequency alternating voltage, whereas the lateral electrodes are arranged in front of the central electrode relative to the direction of flow and form the dielectrical field barrier substantially parallel to the direction of flow.

If the central electrode has a widened-out area, e.g., in the form of projecting electrode segments or a Y-shaped or T-shaped fanned-out area, this can result in advantages for the reliability of the holding of particles counter to the flow forces. If the hexode electrode arrangement is provided with a counterelectrode on mass potential that is arranged centrally in front of the lateral electrodes, relative to the direction of flow, a closed field cage can be advantageously formed. In particular, given a control of the electrodes with a 60° phase shift the cage formed by the hexode electrode arrangement can be symmetrically closed.

The electrode arrangement with at least one pair of straight electrode strips arranged on the bottom and cover surfaces of the channel and extending transversely to the longitudinal direction of the channel constitutes another independent subject matter of the invention. This electrode arrangement advantageously makes possible the holding of straight particle rows within which the individual particles can still be identified and in particular measured.

Further details and advantages of the invention are described in the following with reference made to the attached drawings that show as follows:

FIGS. 1 to 5: Different embodiments of microsystems in accordance with the invention (sections) designed to realize the process of the invention,

FIG. 6: Different embodiments of hexode electrode arrangements in accordance with the invention,

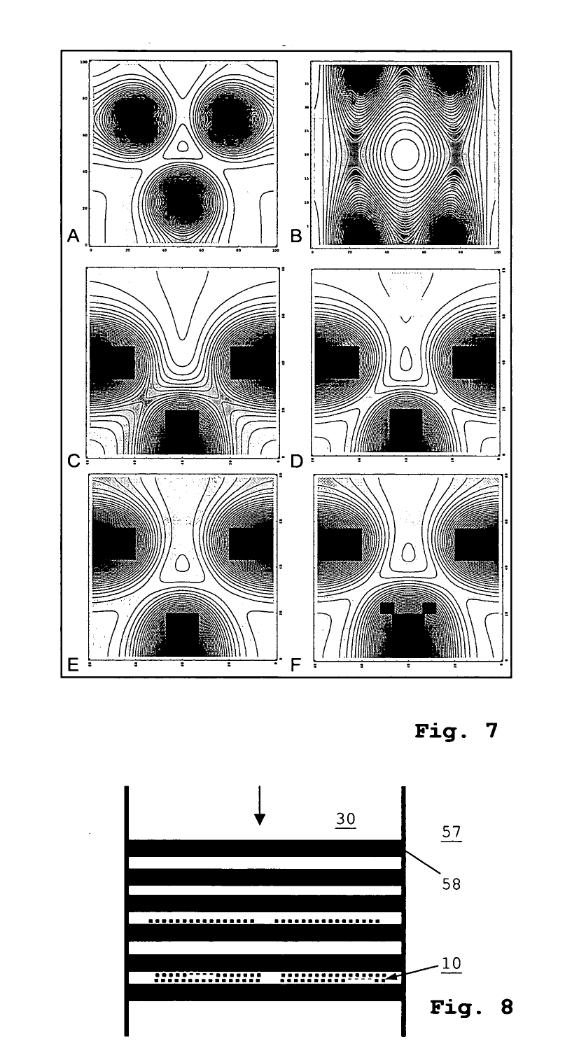

FIG. 7: Illustrations of potential courses generated with hexode electrode arrangements in accordance with the invention,

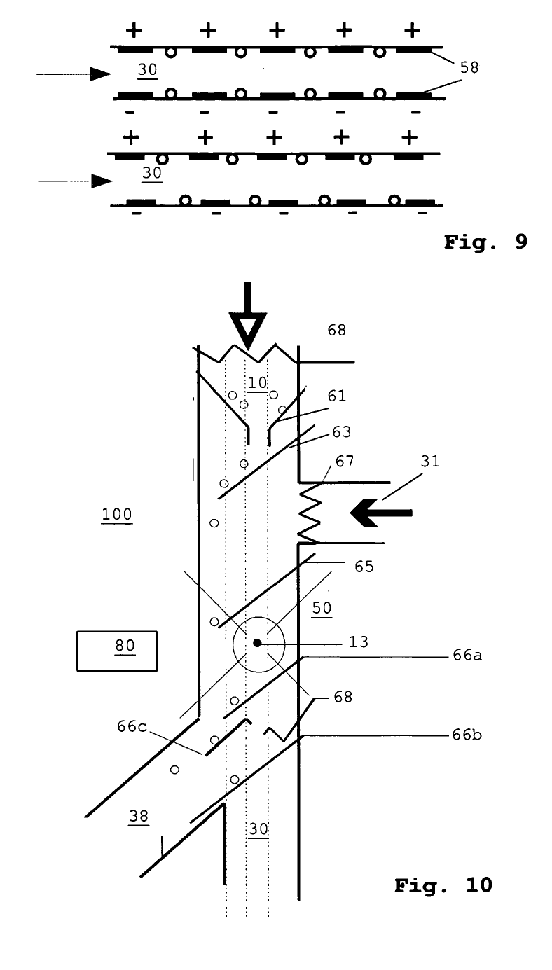

FIGS. 8, 9: Different embodiments of holding devices in accordance with the invention with strip electrodes,

FIG. 10: Another embodiment of a microsystem in accordance with the invention designed to realize the particle sorting in accordance with the invention, and

FIGS. 11, 12: Illustrations of conventional Microsystems.

The invention is realized with a fluidic microsystem whose construction, mode of operation and additional devices per se are known and are therefore not separately described here. Reference is made in the following explanation solely to a section of a microsystem with a main channel, at least one mouth of a lateral channel and with at least one holding device arranged downstream from the mouth. Several such combinations can be arranged in the microsystem in accordance with the invention. The invention is explained in the following by way of example with reference made to the positioning of particles in the holding device with dielectrical forces. The realization of the invention is not limited to this type of holder. Holding devices based on other field effects such as, e.g., laser tweezers or ultrasonic holders with at least one focus can be used in an analogous manner.

FIG. 1 shows a section of a microsystem 100 comprising main channel 30 and lateral channel 31 that merges at mouth 32 into main channel 30. In this embodiment a T-shaped channel coupling is provided. Carrier liquid 40 in which particles 10 are suspended flows through main channel 30 in the direction of arrow A. Particles 10 can comprise, e.g., a particle mixture of different particle types 11, 12. Reaction liquid 20 with which at least one particle 13 is to be treated flows through lateral channel 31 in the direction of arrow B.

Holding device 50, in which the at least one particle is to be held fast at least temporarily for treatment with the reaction liquid is provided downstream, that is relative to the direction of flow after mouth 32. In the example shown, holding device 50 comprises eight electrodes in an octopole electrode arrangement (for the sake of clarity only four electrodes 51 are shown on the bottom or cover surface of main channel 30). The electrodes of holding device 50 are controlled in a per se known manner in such a way that field cage 55 closed on all sides is formed with a potential minimum, e.g., in the middle of holding device 50. Reference numeral 80 refers to a measuring device for detecting a property of the particle in holding device 50.

Aligning device 60 with dielectrophoretically acting aligning element 61 and downstream dielectrophoretical deflector element 63 is provided upstream, that is, relative to the direction of flow, in front of mouth 32. It is not obligatorily necessary that aligning device 60 is arranged in the direction of flow in front of mouth 32. However, the aligning device is advantageous for a reliable loading of holding device 50 with particles 10 or with selected particles.

Main channel 30 has, e.g., dimensions of 400 μm×40 μm (width/height). The particles comprise, e.g., biological cells, cell components, biological macromolecules or synthetic particles. Carrier liquid 40 is, e.g., a physiological saline solution. Reaction liquid 20 comprises, e.g., a physiological saline solution. Alternatively, the reaction liquid comprises, e.g., a wash solution or a solution with different substance compounds, in particular aqueous compounds such as, e.g., with agents that initiate a reaction in biological cells, substances that are to be tested for their potential in inhibiting or amplifying a cellular signal (e.g., membrane potential, the opening or closing of ionic channels, receptor actuation), ligands that can bond to a plasma membrane receptor, fluorogenic substances that form a fluorescent substance in cells and/or substances that are to be investigated regarding the influencing of vitality of a cell or the initiation of apoptosis.

Typical flowthrough amounts of the carrier liquid and reaction liquids are, e.g., 0.3 to 3 nl/s. The distance of holding device 50 from mouth 32, in particular the distance of the potential minimum of holding device 50 from the mouth is preferably selected to be in a range of 50 μm to 2 mm. In general, the distance is preferably at least equal to the width of main channel 30.

In order to realize the process of the invention particles 10 are moved with carrier liquid 40 in the direction of flow (A) along the longitudinal direction of main channel 30. An aligning of particles 10 takes place on aligning device 60 under the action of the funnel-shaped field barrier of aligning element 61, as is known per se from fluidic microsystem technology. The particles subsequently strike deflector element 63, during which the one particle type 11 (open circles) is laterally deflected from the deflector element whereas the other particle type (filled circles) is moved further without deflection. The deflected particles are conducted past holding device 50 while the desired, non-deflected particles can be trapped by holding device 50 (e.g., particle 13).

When the positioning of particle 13 has been detected in holding device 50, e.g., with optical means or by an electrical impedance measurement, reaction liquid 20 is supplied through lateral channel 31. The supplying of reaction liquid 20 takes place by actuating a pump device (not shown). The reaction liquid is deflected into main channel 30 by approaching carrier liquid 40. The reaction liquid flows through holding device 50 with a direction of flow parallel to direction of flow A of the carrier liquid, that is, in the longitudinal direction of main channel 30. Since the distance of holding device 50 from mouth 32 and the flowthrough rate of the carrier and of the reaction liquids are known, the beginning of the liquid treatment of particle 13 relative to the actuation of the pump device can be precisely determined. The reaction of particle 13 to reaction liquid 20 can be observed, e.g., by a fluorescence measuring with a microscope directed onto holding device 50. For example, the charging kinetics of the fluorescent dye into particle 13 is detected with the fluorescence measurement on held particle 13.

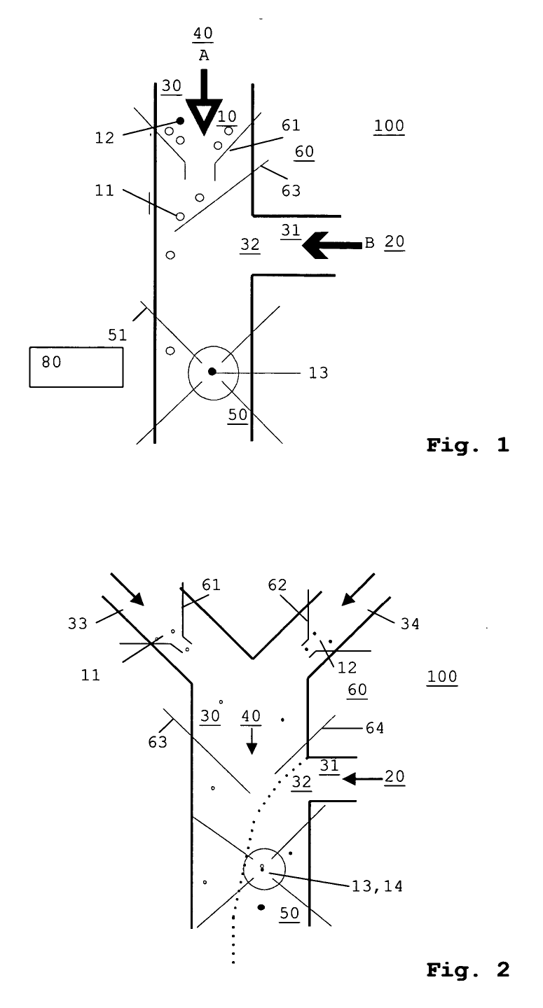

FIG. 2 shows an embodiment in which particles 10 flow together from two partial channels 33, 34 into main channel 30 into which lateral channel 31 with reaction liquid 20 empties at mouth 32. In this instance, aligning device 60 comprises two aligning elements 61, 62 and two deflector elements 63, 64. Reaction liquid 20 forms a charging current parallel to the direction of flow of carrier liquid 40. Since the flows in the microsystem are formed without turbulence and in a laminar manner, the charging current of reaction liquid 20 is advantageously delimited from carrier liquid 40. The boundary is sketched in by way of example with a dotted line.

The exemplary embodiment according to FIG. 2 provides that different particle types 11, 12 flow through partial channels 33, 34 into main channel 30 during which a particle 13, 14 of each particle type is trapped in the field cage of holding device 50 by a suitable controlling of aligning device 60. As soon as the common positioning of both particles is detected in the field cage a reaction can be observed between the particles and the dependency of the reaction on the supplied reaction liquid. Reactions between homogeneous particles can also be observed.

The embodiment of the invention shown in FIG. 3 illustrates the principle of a reference measurement in accordance with the invention. Two aligning elements 61, 62 are provided in main channel 30 as aligning device 60. Particles 10 approaching suspended in carrier liquid 40 are focused with aligning elements 61, 62 onto two separate flow tracks with one directed onto holding device 50 and one onto reference holding device 70. Two deflector elements 63, 64 are arranged between aligning elements 61, 62 and holding devices 50, 70 with which deflector elements other approaching particles can be guided onto a central flow path and conducted through between holding devices 50, 70. Reference numeral 90 refers to a reference measuring device for detecting a property of the reference particle in reference holding device 70.

When both holding devices 50, 70 are each charged with a particle 13, 15, reaction liquid 20 is supplied through lateral channel 31. As a consequence of the delimitation between the charging flow of reaction liquid 20 and carrier liquid 40 (dotted line 41), only particle 13 in holding device 50 is rinsed by the reaction liquid whereas particle 15 used as reference particle remains suspended in reference holding device 70 exclusively in carrier liquid 40.

The reference measurement comprises, e.g., an optical or electrical measurement on each of particles 13, 15 and a correlation of both measured values, e.g., by a subtraction. This embodiment of the invention advantageously makes possible a direct comparison of the measured results of particle 13 with the measured results of uninfluenced particle 15.

FIG. 3 illustrates an important feature of the invention that can be realized independently of the making available of reference holding device 70, that is, even, e.g., in the embodiment according to FIG. 1. Holding device 50 is generally constructed in such a manner that the at least temporary positioning of the particle to be treated takes place downstream from mouth 32 in the side of main channel 30 into which the lateral channel empties. The potential minimum of holding device 50, e.g., of the dielectrical field cage, is arranged outside of the middle of main channel 30 shifted toward lateral wall 35 in which mouth 32 of lateral channel 31 is also formed. The shifting of the holding device or at least of the potential minimum toward the channel edge has the advantage that the particle in holding device 50 is rinsed by the reaction liquid even in the case of fluctuating flowthrough amounts of the reaction- and carrier liquids. The charging current of reaction liquid 30 is advantageously formed in a homogeneous and continuous manner. This makes possible an increased reproducibility and accuracy of the measured results obtained for the treated particle. Another advantage of the positioning of the particle shifted toward lateral wall 35 is that a relatively weak flow of the reaction liquid can be formed from lateral channel 31. If holding device 50 positions the particle in the channel middle the reaction fluid must be introduced, if necessary, with an elevated flowthrough amount.

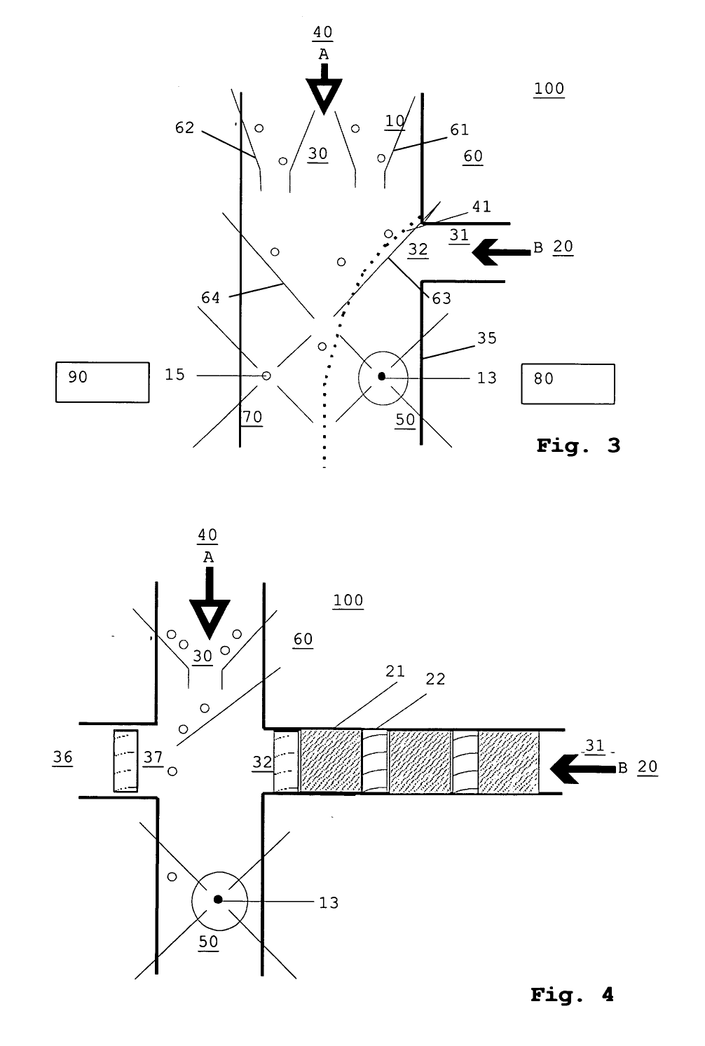

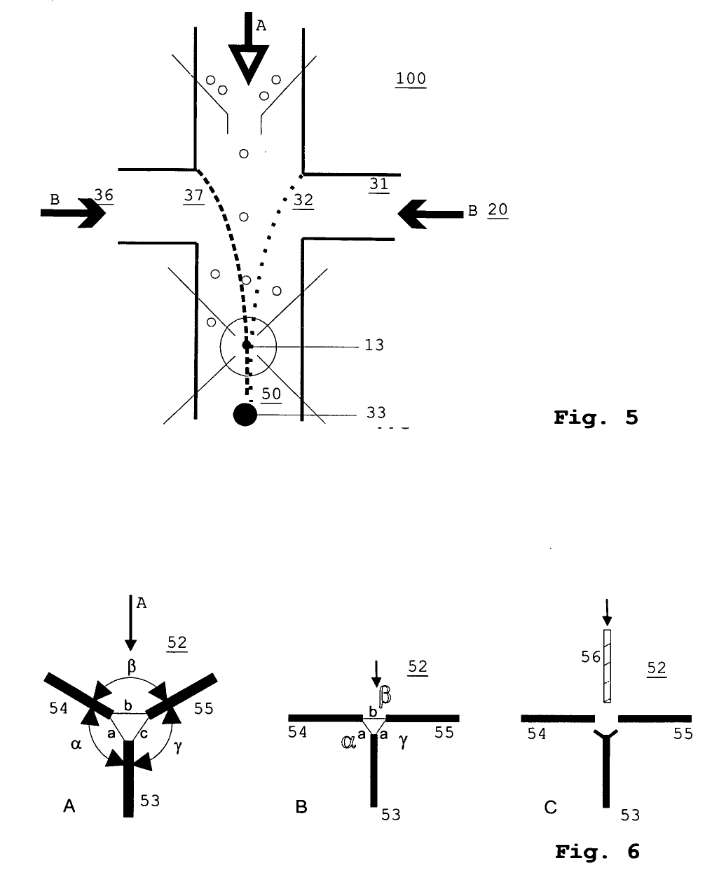

According to the invention several lateral channels 31, 36 can empty into main channel 30 as is illustrated by way of example in FIGS. 4, 5. Lateral channels 31, 36 can form an intersection at which opposing, superposed mouths 32, 37 wash one or more reaction liquids simultaneously or successively into the main channel. It can be provided as an alternative that the lateral channels are arranged offset to direction of flow A in main channel 30. In this instance mouths 32, 37 can be formed on the same side of main channel 30. In general, the angle between a lateral channel and the main channel can be selected in accordance with the concrete requirements and structural conditions in the microsystem.

The embodiment according to FIG. 4 shows a main channel 30 with alignment device 60 (see FIG. 1) and holding device 50 arranged downstream from mouths 32, 37. In this instance the potential minimum of holding device 50 is preferably arranged in the middle of main channel 30 in order that a uniform influence of the reaction liquids from lateral channels 31, 36 is ensured.

FIG. 4 illustrates the supplying of reaction liquid 20 as a segmented liquid column in which active segments 21 of reaction liquid 20 alternate with passive segments 22 of a barrier liquid.

Active segments 21 contain the at least one desired reaction liquid, e.g., based on an aqueous solution. They are separated from each other by passive segments 22. The barrier liquid in passive segments 22 comprises, e.g., oil extending as diffusion barrier over the entire cross section of lateral channel 31. The supplying of the reaction liquid in the form of a segmented liquid column has the advantage that the charging of the particle in holding device 50 can take place according to a certain time scheme with one or several different reaction liquids. If several reaction liquids are arranged in the liquid column the treatment of the at least one particle in the holding device can take place according to a certain process protocol with different substances. Furthermore, as long as a passive segment 22 is present at mouth 32 an unintended diffusion of a reaction liquid into carrier liquid 41 is avoided. The time is advantageously fixed in a defined manner with the diffusion barriers at which the particular reaction liquid of the active segment 21 following a certain passive segment 22 reaches particle 13.

FIG. 5 schematically illustrates the simultaneous charging of particle 13 in holding device 50 with two different reagents.

The flowthrough amounts can advantageously be adjusted in such a manner in accordance with directions of flow B that the different reaction liquids do not meet each other until at the location of particle 13 and can not react chemically with each other until there. The confluence can also be provided further downstream. It can be provided as an alternative that the different reaction liquids are compounded with each other upstream already, that is, relative to direction of flow A of the carrier liquid in front of holding device 50 and accordingly chemically react, e.g., with each other.

FIGS. 6, 7 illustrate the design and the function of holding device 52 preferably used to realize the invention. Holding device 52 comprises six electrodes of which three electrodes are arranged on the bottom and cover surfaces of the main channel. For the sake of clarity only three electrodes 53, 54, 55, e.g., of the bottom surface without the associated connections to a voltage source are shown (electrode triple). Since holding device 52 comprises the three electrode in pairs, thus comprises six electrodes, it is also designated as a hexode electrode arrangement.

The hexode electrode arrangement, that constitutes an independent subject matter of the invention, is characterized in that the electrodes of each electrode triple comprise a central electrode 53 and two lateral electrodes 54, 55, whose free ends are arranged at an distance from each other and that form a field cage (potential well) that is closed or, as the case may be, open counter to direction of flow A when loaded with a high-frequency alternating voltage. The electrodes have, e.g., a strip form. The width of the electrode strips is advantageously 2 μm to 30 μm. In general, the electrodes can have different shapes, e.g., rod-shaped or strip-shaped, and comprise a y-shaped fanned-out area facing counter to the direction of flow.

Central electrode 53 is arranged centrally, relative to the direction of flow, after electrodes 54, 55 extending laterally into the main channel. A particle flowing in is positioned in holding device 52 by the cooperation of the mechanical flow forces of the carrier liquid and/or the reaction liquid and of the dielectrical forces in the potential minimum of the hexode electrode arrangement.

Special advantages of hexode electrode arrangements 52 consist in that a particularly effective field barrier is produced counter to direction of flow A (in the direction of the cage discharge) by central electrode 53. The holding force is increased in comparison to the octopole electrode arrangements (see, e.g., FIG. 1). A rapid and reliable charging of holding device 52 with microobjects is made possible. This is especially advantageous for kinetic measurements on cells or cell components (cell organelles) since only a few molecules suffice to initiate signal cascades and if the charging is too slow diffusion processes could dominate. Another advantage of the hexode electrode arrangements consists in the variable drive of the electrodes.

Partial illustrations A, B and C of FIG. 6 show different variants of hexode electrode arrangements. The different embodiments are distinguished as concerns the distances of free electrode ends a, b and c and the angles between straight electrode strips α, β and γ. According to partial illustration A it is provided that α, γ≧90° and β≦180°. It can be provided in particular that α=β=γ=120°. The distances a, b and c are selected to be, e.g., equal to the height of the main channel (e.g., 40 μm). At a 60° phase drive of the main channel the field cage formed by the electronic structure according to FIG. 6 is always closed. Partial illustration B of FIG. 6 shows a preferred embodiment with α (=γ)=90°. In this variant the field cage is open counter to the direction of flow.

Partial illustration C illustrates other variants that can be provided jointly or individually for optimizing the hexode electrode arrangement. Thus, central electrode 53 is widened out on its free end by projecting device segments. Moreover, a so-called floating or on-mass counterelectrode (electrode pair) 56 is additionally provided. As a result of this design, on the one hand the holding effectiveness of the hexode electrode arrangement can be improved and on the other hand the field cage can be closed counter to direction of flow A. As a consequence thereof, particles remain in holding device 52 even if the movement of the flow of the carrier liquid is temporarily halted.

The following table illustrates various schemes for controlling the hexode electrode arrangement.

| | 1. Electrode plane | | | 2. Electrode plane | | |
|---|---|---|---|---|---|---|
| Electrode | 54 | 55 | 53 | 54 | 55 | 53 |
| 3 Phase | 0 | (2/3)π | (4/3)π | (4/3)π | 0 | (2/3)π |
| control | | | | | | |
| 4 Phase | 0 | π/2 | −π/2 | π | −π/2 | π/2 |
| control | | | | | | |
| 6 Phase | 0 | (2/3)π | (4/3)π | π | (5/3)π | π/3 |
| control | | | | | | |

FIG. 7 illustrates the distribution of potential in the hexode electrode arrangement with 6-phase control (see table), the average quadratic electrical field strength (potential of the dielectrical field strength) being indicated as a contour in selected planes over various hexode electrode arrangements. The partial images show in detail:
A) Potential in the central horizontal plane (xy, parallel to the bottom surface) between the electrodes (black) for a cage of the type in FIG. 6A with (α=β=γ=120°),
B) Potential in the central horizontal plane (xy) between the electrodes for a cage of the type in FIG. 6A with (α=β=120°, scaling in the vertical and horizontal direction is not identical),
C) Potential in the central horizontal plane for a cage of the type in FIG. 6B (α=90°, β=180°) with symmetrical design (electrode tips are in a circle),
D) Potential in the central horizontal plane for a cage of the type in FIG. 6C (α=90°, β=180°) with symmetrical design and floating additional electrodes (gray),
E) Potential in the central horizontal plane for a cage of the type in FIG. 6B (α=γ=90°, β=180°) with symmetrical design, and
F) Potential in the central horizontal plane for a cage of the type in FIG. 6B (α=90° β=180°) with asymmetrical design and reinforced output electrode pair.

The distributions of potential illustrate the formation of the local potential minimum with a sharp field gradient, in particular in the direction of flow on central electrode 54.

According to another independent aspect of the invention holding device 57 can be formed by at least one pair of straight electrode strips 58 extending transversely over the width of main channel 30 and arranged on the bottom and cover surfaces. This design is schematically illustrated in FIGS. 8, 9. A pair of straight electrode strips forms a linear, transversely running field barrier that advantageously ensures a reliable holding even given an elevated charging flow of the reaction liquid. Particles 10 are advantageously arranged in rows adjacent to each other on this field barrier. The aggregate formation that occurs with conventional park electrodes (see FIG. 11) is avoided in this instance. Furthermore, holding device 57 has the advantage that the optical accessibility and the ability to individually observe the particles are retained. The width of the electrode strips and the distance are preferably selected to be in a range of 2 μm to 50 μm.

FIG. 9 shows a sectional view of main channel 30 in direction of flow A with electrode strips sketched in with a superelevated height. A polarity corresponding to a current field direction is indicated on electrodes 58. Electrodes 58 can be arranged according to the upper partial illustration of FIG. 9 opposite each other or, according to the lower partial illustration of FIG. 9, offset relative to each other on the upper and the lower channel sides. The offset of electrodes 58 relative to each other results in an offset of the aligned particles on the lower and the upper channel sides. In a microscopic image the particles located on the bottom appear optically dark and the objects on the upper channel plane appear brighter as a consequence of the offset optical focus.

The sorting function, in accordance with the invention, of a fluidic microsystem 100 is schematically illustrated in figure 10. In addition to the above-described design shown in FIG. 1, microsystem 100 comprises discharge channel 38 that branches off from main channel 30 downstream from holding device 50. Moreover, additional electrodes for aligning and manipulating the particles in microsystem 100 are provided that are arranged individually or in combination in the particular channel sections and furthermore comprise screening electrode 65, sorting electrodes 66a, 66b and 66c, barrier electrode 67 and other holding electrodes 68 in addition to the above-cited electrodes 61 to 64. The electrodes are shown in accordance with their function as straight electrode strips or as bent electrodes consisting of individual straight electrode segments. In modified embodiments of the invention curved electrodes or electrode segments can be provided instead of them in order to obtain certain geometric barrier forms.

A sorting of particles with the microsystem according to figure 10 comprises, e.g., the following steps. When particles 10, e.g., the suspended biological cells, are flowing in through main channel 30 the cells could pass in an unintended manner into lateral channel 31 or into the further course of main channel 30 after the branching off of discharge channel 38. In order to prevent this and to create instead defined stored conditions in the microsystem, barrier electrode 67 and downstream sorting electrode 66b are loaded with high-frequency electrical voltages so that field barriers form that are impervious to the particles.

When the carrier stream is cut in with volume stream V1 through main channel 30, that forms the sorting channel with the desired cells in the embodiment presented, and at the same time a volume stream V2 is started at discharge channel 38 with a discharge pump (not shown), the liquid stream takes place at first from aligning element 61 via deflector element 63 to be engaged into discharge channel 38. In this instance V1>V2, especially preferably V1≅2 V2 is adjusted.

A particle 13 is allowed to pass by deflector element 63 by briefly cutting out the high-frequency electrical voltage and is trapped in holding device 50. In this state holding electrode 68 is driven in order to retain subsequently traveling particles. Screening electrode 65 is switched on correlated in time so that any particles present in the main channel are conducted to discharge channel 38. The screening function of screening electrode 65 is advantageously supported by the flow forces exerted during the introduction of the reaction liquid through lateral channel 31 with volume stream V3 into main channel 30 onto any particles present in front of screening electrode 65. An adaptation of volume streams V1 and V2 takes place, to the extent possible simultaneously with the engaging of volume stream V3, in such a manner that V2_{(new)}≅V1_{(new)}+V3. This brings it about that the entire liquid is substantially removed via channel 38 so that as little reaction liquid as possible passes into sorting channel 30.

Screening electrode 65 is preferably arranged upstream directly in front of holding device 50 in order to remove any particles present in front of holding device 50 as effectively as possible. Furthermore, the function of the screening electrode prevents other particles (cells) from being exposed outside of holding device 50 to the reaction liquid from lateral channel 31.

While the reaction liquid is being conducted into the main channel the treatment of the fixed cell takes place in accordance with the principles described above. Sorting electrode 66b is still switched on during the treatment in order to deflect any cells present downstream from holding device 50 into discharge channel 38.

An evaluation of treated cell 13 takes place with measuring device 80 after or during the liquid treatment. Cage electrodes of holding device 50 arranged downstream are subsequently switched off so that cell 13 is released from holding device 50. The further movement takes place under the action of the carrier stream in main channel 30. This is supported, if the cell was tested negatively, by a liquid subsequently flowing in via lateral channel 31. In the case of a positively tested cell the goal is to turn off volume stream V3 (V3=0) and to move cell 13 into channel 30 only by the carrier stream. However, in this instance volume stream V1 is adapted in such a manner that it is greater than volume stream V2 and even greater than volume stream V1 before the introduction of the reaction liquid to channel 31 in order that a positively tested cell is moved as rapidly as possible into channel 30. During the release of the measured cell the upstream electrodes, in particular deflector element 63 and screening electrode 65 are switched on so that no undesired particles can pass into the flow path of the measured particle.

One of sorting electrodes 66a or 66b is switched on in as a function of the result of the evaluation. If the evaluation result was negative, that is, e.g., a sought fluorescence marker was not found on a cell, first sorting electrode 66a is switched on in order that the cell is removed into discharge channel 38 (waste channel). Otherwise, only auxiliary electrode 66c is switched on and the positively measured cell is allowed to pass through by sorting electrodes 66a and 66b.

The function of main channel 30 cited here by way of example as sorting channel for the positively tested cells and of discharge channel 38 as outlet for negatively tested cells can be reversed.

The combination of sorting electrodes 66a and 66c has the particular advantage that all particles deflected on deflector element 63 are automatically removed into discharge channel 38 while of the particles measured in holding device 50 only the negatively tested particles are deflected into discharge channel 38. To this end sorting electrode 66c is arranged downstream from sorting electrode 66a eccentrically on the sides of the main channel at which discharge channel 38 branches off whereby an overlapping with sorting electrode 66a is provided.

The design according to FIG. 10 can be advantageously modified in such a manner that lateral channel 31 on the left side of the main channel in FIG. 10 and also the components 61 and 50 are arranged offset to the left. The particular advantage of this embodiment is that the reaction liquid can flow off from channel 31 directly into channel 38, thus avoiding a contamination of main channel 30 with reaction liquid. In this embodiment the remaining electrodes can also be arranged in an adapted or mirror-inverted manner.

The features of the invention disclosed in the above description, the claims and the drawings can be significant individually as well as in combination for realizing the invention in its various embodiments.

1. A process for the treatment of at least one particle with at least one reaction liquid in a main channel of a fluidic microsystem, with the steps:
movement of the at least one particle with a carrier liquid flowing in a longitudinal direction of the main channel up to a holding device,
at least a temporary holding of the at least one particle under the action of a holding force exerted by the holding device, and
supplying of the reaction liquid from at least one lateral channel into the main channel so that the at least one held particle is rinsed by the reaction liquid, wherein
the holding device is arranged downstream after a mouth of the lateral channel in the main channel and the reaction liquid flowing through the holding device with a direction of flow running in the longitudinal direction of the main channel, and
the holding of the at least one particle comprises a contactless fixing with a holding force acting in a contactless manner.

2. The process according to claim 1, in which the at least one particle is held in the holding device on a local potential minimum or along a potential line extending perpendicularly to the longitudinal direction of the main channel.

3. The process according to claim 1 or 2, in which the at least one particle is held by the holding device on a side of the main channel limited by a channel wall in which the mouth of the lateral channel is formed.

4. The process according to claim 1 or 2, in which the at least one particle is held by the holding device in the middle of the main channel.

5. The process according to claim 1, in which the at least one particle is held by the holding device with dielectrophoretical, optical and/or acoustically imparted holding forces.

6. The process according to claim 1, in which the at least one particle is held by the holding device by a combination of at least one of dielectrophoretical, optical and acoustically imparted holding forces and flow forces.

7. The process according to claim 6, in which a field barrier is generated with the holding device which barrier narrows down in the longitudinal direction of the main channel down to the local potential minimum.

8. The process according to claim 6, in which at least one field barrier is generated with the holding device which barrier extends linearly and perpendicularly to the longitudinal direction of the main channel.

9. The process according claim 1, in which at least one measurement on the particle takes place in the holding device.

10. The process according to claim 6, in which at least one reference measurement takes place on at least one reference particle in a reference holding devices, the reference particle being exposed in the reference holding device exclusively to the carrier liquid without the reaction liquid or some another reaction liquid.

11. The process according to claim 1, in which the at least one reaction liquid is washed in as a segmented liquid column in which active segments alternate with the at least one reaction liquid and passive segments of a barrier liquid.

12. The process according to claim 1, in which the at least one particle is positioned at an distance in a range of 50 μm to 4 mm from the mouth of the lateral channel.

13. The process according to claim 1, in which a release of the at least one particle from the holding device and another movement of the at least one particle in the main channel or a discharge channel take place after the holding of the at least one particle and the supplying of the reaction liquid.

14. The process according to claim 13, in which the movement into the main channel or the discharge channel takes place as a function of a result of the measurement on the at least one particle in the holding device.

15. The process according to claim 14, in which the movement of the at least one particle into the main channel or the discharge channel results in a sorting of particles with predetermined properties into the main channel.

16. The process according to claim 13, in which the movement into the discharge channel comprises a deflection of the at least one particle under the action of high-frequency electrical fields.

17. The process according to claim 1, in which the at least one lateral channel is separated from the main channel by a dielectrophoretical field barrier so that no particles can enter into the lateral channel.

18. The process according to at least one of the preceding claim 1, in which a field barrier is generated during the holding of the at least one particle and the supplying of the reaction liquid on the upstream side of the holding device with which field barrier particles flowing in subsequently are retained or deflected from the holding device.

19. A fluidic Microsystems, especially for the treatment of at least one particle suspended in a carrier liquid, which comprises:
a main channel adapted to receive a flow of the carrier liquid and to which a lateral channel for supplying a reaction liquid is connected at least one mouth, and
a holding device adapted to hold at least temporarily the at least one particle, wherein
the main channel is adapted to receive a flow of the reaction liquid that flows with a direction of flow running in the longitudinal direction of the main channel through the holding device,
the holding device is arranged downstream after the mouth of the lateral channel, and
the holding device is adapted for a contactless fixing of the at least one particle.

20. The microsystem according to claim 19, in which the holding device is adapted to generate at least one local potential minimum or at least one potential line extending perpendicularly to the direction of flow of the reaction liquid.

21. The microsystem according to claim 19, in which the holding device is arranged on a side of the main channel limited a the channel wall in which the mouth of the lateral channel is formed.

22. The microsystem according to claim 19, in which the holding device is arranged in the middle of the main channel.

23. The microsystem according to claim 19, in which the holding device is designed to exert dielectrophoretical, optical and/or acoustically imparted holding forces.

24. The microsystem according to claim 23, in which the holding device is adapted to form a dielectrical field barrier that narrows down in the longitudinal direction of the main channel to a local potential minimum.

25. The microsystem according to claim 24, in which the holding device comprises at least one central electrode centrally arranged on the downstream side of the holding device.

26. The microsystem according to claim 25, in which the holding device comprises at least two lateral electrodes extending on the upstream side of the central electrode into the channel.

27. The microsystem according to claim 26, in which the holding device comprises at least one counterelectrode arranged on the upstream side of the lateral electrodes.

28. The microsystem according to claim 23, in which the holding device is adapted to form at least one field barrier extending linearly and transversely to the longitudinal direction of the main channel.

29. The microsystem according to claim 19, in which at least one measuring device is provided for measuring the particle in the holding device.

30. The microsystem according to claim 29, in which at least one reference measuring device is provided for reference measuring on at least one reference particle in a reference holding device.

31. The microsystem according to claim 19, in which the holding device is provided for the purpose of positioning the at least one particle at a distance in a range of 50 μm to 4 mm from the mouth of the lateral channel.

32. The microsystem according to claim 19, in which at least one discharge channel is arranged downstream after the holding device.

33. The microsystem according to claim 31, in which at least one sorting electrode is provided between the holding device and the at least one discharge channel.

34. The microsystem according to claim 19, in which at least one barrier electrode is arranged in the at least one lateral channel that prevents particles from entering into the at least one lateral channel.

35. The microsystem according to claim 19, in which one screening electrode is arranged between the mouth of the at least one lateral channel and between the holding device with which screening electrode the particles can be retained or deflected from the holding device.

36. An electrode arrangement for the contactless holding of suspended particles in a channel of a fluidic microsystem, which arrangement comprises at least three pairs of electrodes, the electrodes being respectively arranged on bottom surfaces and cover surfaces of the channel and each comprising a central electrode and two lateral electrodes, the central electrodes being adapted to form a dielectrical field barrier transversely to a direction of flow (A) in the channel when loaded with a high-frequency alternating voltage, and the lateral electrodes being arranged in front of the central electrode, relative to the direction of flow (A).

37. The electrode arrangement according to claim 36, in which at least one of the central electrodes has a broadening on its free end.

38. The electrode arrangement according to claim 36, that is provided with at least one counterelectrode operated on mass potential or free (floating) potential and arranged centrally in front of the lateral electrodes, relative to the direction of flow (A).

39. An electrode arrangement for holding suspended particles in a channel of a fluidic microsystem, which electrode arrangement comprises at least one pair of straight electrode strips arranged on the bottom and cover surfaces of the channel and extending transversely to the longitudinal direction of the channel.

40. The electrode arrangement according to claim 39, in which the electrode strips are aligned opposite each other on the bottom and cover surfaces.

41. The electrode arrangement according to claim 39, in which the electrode strips are aligned in an offset manner on the bottom and cover surfaces.
